(19) United States
(12) Patent Application Publication
(10) Pub. No.: US 2015/0381766 A1
(43) Pub. Date: Dec. 31, 2015

(54) APPLICATION TRANSFER SYSTEM, APPLICATION TRANSFER METHOD, TERMINAL, AND PROGRAM

(71) Applicant: RAYTRON, INC., Osaka-shi, Osaka (JP)

(72) Inventors: Mitsuji YOSHIDA, Kishiwada-shi, Osaka (JP); Yutaka USUI, Osaka-shi (JP)

(21) Appl. No.: 14/768,547

(22) PCT Filed: Feb. 18, 2013
(86) PCT No.: PCT/JP2013/053849

§ 371 Date: Aug. 18, 2015

(51) Int. Cl. H04L 29/08; H04L 12/24

(52) U.S. Cl. CPC H04L 67/34; H04L 41/0806; H04L 67/325

(57) ABSTRACT

An application transfer system transfers an application between terminals A, B each operated on a predetermined OS. When the terminal B receives from the terminal A a request to transfer an application (S22), the terminal B checks an OS for the application, and executes the application after making an adjustment so that the OS of the terminal B becomes the same as that for the application (S24). As a result, an application transfer system and an application transfer method can be provided which can transfer an application between any devices.

### TECHNICAL FIELD

The present invention relates to application transfer systems, application transfer methods, terminals, and programs, and more particularly to application transfer systems, application transfer methods, terminals, and programs which can transfer an application between any devices.

### BACKGROUND ART

Conventionally, there are a need for users playing a game on a home personal computer (PC) to continue the game while traveling with transportation of some kind. A method based on this need is disclosed in, e.g., Japanese Unexamined Patent Application Publication No. 2012-517767 (Patent Literature 1). According to Patent Literature 1, by operation of content-transfer user interface control on the user's mobile phone, state information of the game is transferred to the phone and the player can resume the game on a small screen.

### CITATION LIST

### Patent Literatures

PTL 1: Japanese Unexamined Patent Application Publication No. 2012-517767

### SUMMARY OF INVENTION

### Technical Problem

Conventional methods for continuing an application such as a game on a different device includes the above method. According to the above method, the user plays a game on a home PC as the user's input information is sent to a cloud processor and the cloud processor interacts with the game and sends a corresponding MPEG stream back to the user's PC. The user switches the destination for the game to his/her mobile phone to continue the game on the mobile phone.

In this method, however, connection to the cloud system is necessary, which complicates the configuration and increases the cost.

The present invention was developed to solve the above problem, and it is an object of the present invention to provide an application transfer system, an application transfer method, a terminal, and a program which can transfer an application between any devices.

### Solution to Problem

An application transfer system transfers an application between first and second terminals each having a predetermined OS. The first terminal includes transmitting means for transmitting to the second terminal a request to transfer the application and information specifying the OS. The second terminal includes virtualization software that virtualizes operation of an OS different from the OS of the second terminal, receiving means for receiving the transfer request, determining means for determining if the OS for the application received by the receiving means is the same as the OS of the second terminal, and control means for performing control to execute the application as it is if it is determined by the determining means that the OS for the application requested to be transferred is the same as the OS of the second terminal, and to start the virtualization software to execute the application if it is determined by the determining means that the OS for the application requested to be transferred is different from the OS of the second terminal.

Preferably, the transmitting means transmits, to the second terminal, accompanying information that defines a state at a time the application is transferred.

It is preferable that the accompanying information include information indicating an executed part of a program at a time execution of the program on the first terminal is stopped and a state of the application at the time execution of the program on the first terminal is stopped.

The accompanying information may include a memory size being used by the application.

The first terminal may have the virtualization software.

Another aspect of the present invention is directed to a method for transferring an application. The application transfer method transfers an application between first and second terminals each having a predetermined OS and a memory. The method includes the steps of: transmitting from the first terminal to the second terminal a request to transfer the application; receiving by the second terminal the transfer request from the first terminal; determining by the second terminal if the OS that runs the application requested to be transferred is the same as the OS of the second terminal; and executing the application as it is if it is determined that the OS for the application requested to be transferred is the same as the OS of the second terminal, and starting virtualization software to execute the application if it is determined that the OS for the application requested to be transferred is different from the OS of the second terminal.

Still another aspect of the present invention is directed to a terminal that receives from an external terminal having a predetermined OS an application running on the external terminal, and that can run the application. The terminal includes: virtualization software that virtualizes operation of an OS different from an OS of the terminal; receiving means for receiving from the external terminal a request to transfer the application and information specifying the OS of the external terminal; determining means for determining if the OS for the application received by the receiving means is the same as the OS of the terminal; and control means for performing control to execute the application as it is if it is determined by the determining means that the OS for the application requested to be transferred is the same as the OS of the terminal, and to start the virtualization software to execute the application if it is determined by the determining means that the OS for the application requested to be transferred is different from the OS of the terminal.

Yet another aspect of the present invention is directed to a program that causes a second terminal as a computer to receive an application running on an external first terminal having a predetermined OS and to run the application. The second terminal includes virtualization software that virtualizes operation of an OS different from an OS of the second terminal. The program is run as receiving means for receiving from the first terminal a request to transfer the application and information specifying the OS of the first terminal, determining means for determining if the OS for the application received by the receiving means is the same as the OS of the second terminal, and control means for performing control to execute the application as it is if it is determined by the determining means that the OS for the application requested to be transferred is the same as the OS of the second terminal, and to start the virtualization software to execute the application if it is determined by the determining means that the OS for the application requested to be transferred is different from the OS of the second terminal.

### Advantageous Effects of Invention

In an application transfer system that transfers an application between first and second terminals each having a predetermined OS, the second terminal that has received a transfer request executes the application as it is if the application can run on the OS of the second terminal, and otherwise, starts software for virtualizing an OS to execute the application.

As a result, an application transfer system, an application transfer method, a terminal, and a program can be provided which can transfer an application between any devices.

### BRIEF DESCRIPTION OF DRAWINGS

FIG. 1 is a schematic diagram showing the state where an application is transferred according to an embodiment of the present invention.

FIGS. 2A and 2B are block diagrams showing the configuration of a mobile terminal and a car navigation system.

FIG. 3 is a diagram showing the configuration of a main memory of the mobile terminal.

FIG. 4 is a diagram showing the configuration of the main memory after an application is loaded on the mobile terminal.

FIG. 5 is a diagram showing the configuration of the main memory after a memory of a requested size is allocated to the application as a work area.

FIG. 6 is a flowchart showing operation of an OS of a mobile terminal and an OS of a car navigation system when transferring an application.

FIG. 7 is a flowchart showing processing after the receiving terminal receives the application and its accompanying information.

FIGS. 8A and 8B are diagrams showing the configuration of the main memories of the transmitting and receiving terminals before transfer of the application.

FIGS. 9A and 9B are diagrams showing the configuration of the main memories of the transmitting and receiving terminals after transfer of the application.

FIG. 10 is a schematic diagram showing the configuration of the transmitting and receiving terminals in the case where the OS of the receiving terminal cannot run the application.

### DESCRIPTION OF EMBODIMENTS

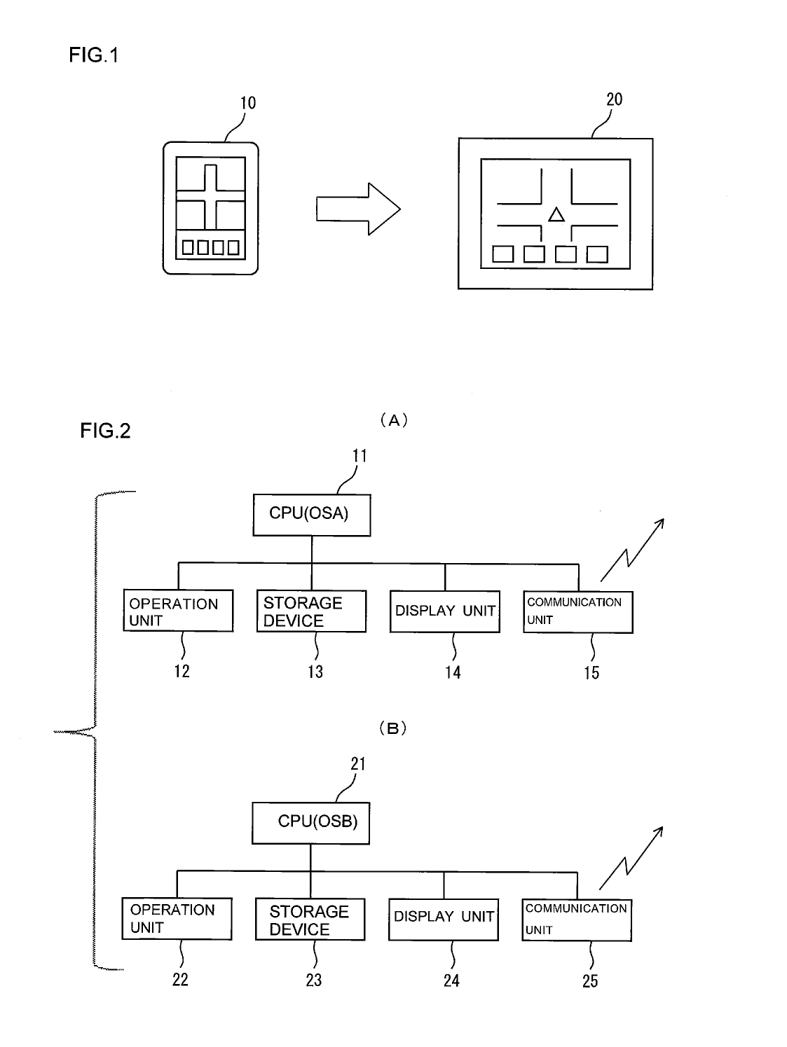

An embodiment of a method for transferring an application according to the present invention will be described below with reference to the accompanying drawings. FIG. 1 is a schematic diagram showing, as an example of transfer of an application, the case where the user who has started a map application and is looking at the map on a mobile terminal 10 such as a mobile phone transfers the map application to a car navigation system 20.

FIG. 2A is a block diagram showing the configuration of the mobile terminal 10. Referring to FIG. 2A, the mobile terminal 10 includes a CPU 11 that controls the entire mobile terminal 10, an operation unit 12, a storage device 13, a display unit 14 such as a display, and a communication unit 15. The communication unit 15 operates as transmitting means. The CPU 11 and applications are driven by an operating system (OS) A. Hereinafter, this OS is referred to as the “OSA,” and an OS that is driven by B is referred to as the “OSB.”

FIG. 2B is a block diagram showing the configuration of the car navigation system 20. Referring to FIG. 2B, the car navigation system 20 includes a CPU 21 that controls the entire car navigation system 20, an operation unit 22, a storage device 23, a display unit 24 such as a display, and a communication unit 25. The communication unit 25 operates as receiving means. The CPU 21 is driven by the OSB.

The CPU 11 and the OSA of the mobile terminal 10 and the CPU 21 and the OSB of the car navigation system 20 can execute a map application, and the communication units 15, 25 can transmit and receive the application.

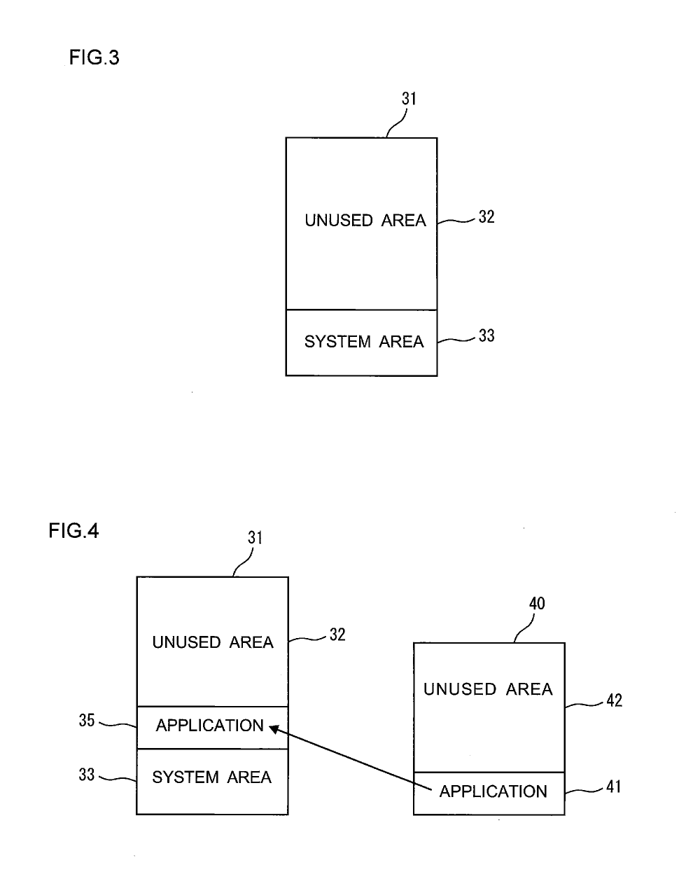

First, the internal operation of the OSA in the mobile terminal 10 will be described. FIG. 3 is a diagram showing a main memory 31 in the storage device 13, illustrating operation of the OSA. A part of the main memory 31 is always used by the OSA, and the OSA performs basic operations such as input/output control of the operation unit 12, the display unit 14, etc. of the mobile terminal 10 and memory management of the main memory 31. An area that is used for the basic operations of the OSA is a system area 33. The system area 33 is an area that is required to run any application. The area other than the system area 33 in the main memory 31 is an unused area 32.

FIG. 4 shows the case where the user of the mobile terminal 10 has started a game application in this state. FIG. 4 is a diagram showing the main memory 31 of the mobile terminal 10 and an external SD card 40 connected to the mobile terminal 10. It is assumed that the program of the application itself has been stored in the SD card 40. The SD card 40 includes an application area 41 that stores data including the program of the application, and an unused area 42 where no data has been stored.

When the user operates the operation unit 12 etc. of the mobile terminal 10 to start the application, the OSA copies data of the application stored in the SD card 40 to the unused area 32 in the main memory 31. An application area 35 is thus created in the main memory 31, as shown on the left side of the figure.

The CPU 11 starts the application and starts operation specific to each application after initialization. Since a work area specific to each application is required, the application requests the OSA to allocate the memory to the application.

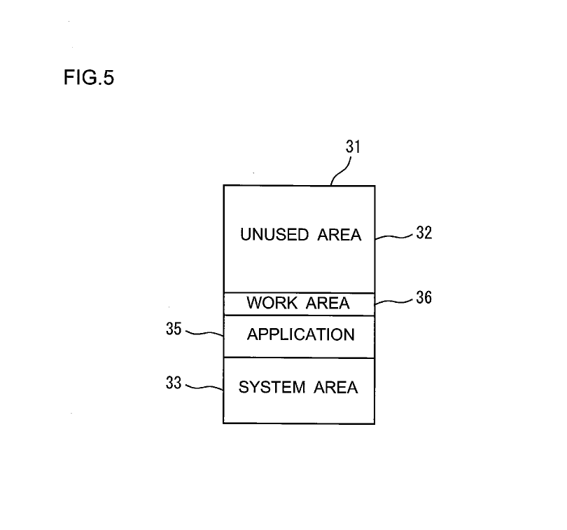

The OS allocates the memory of a requested size to the application as a work area. This state is shown in FIG. 5. As shown in FIG. 5, a work area 36 is provided adjacent to the application area 35.

When the user terminates the application, the OS releases the work area and the area allocated to the application. Allocation of the main memory in this state is the same as that shown in FIG. 3.

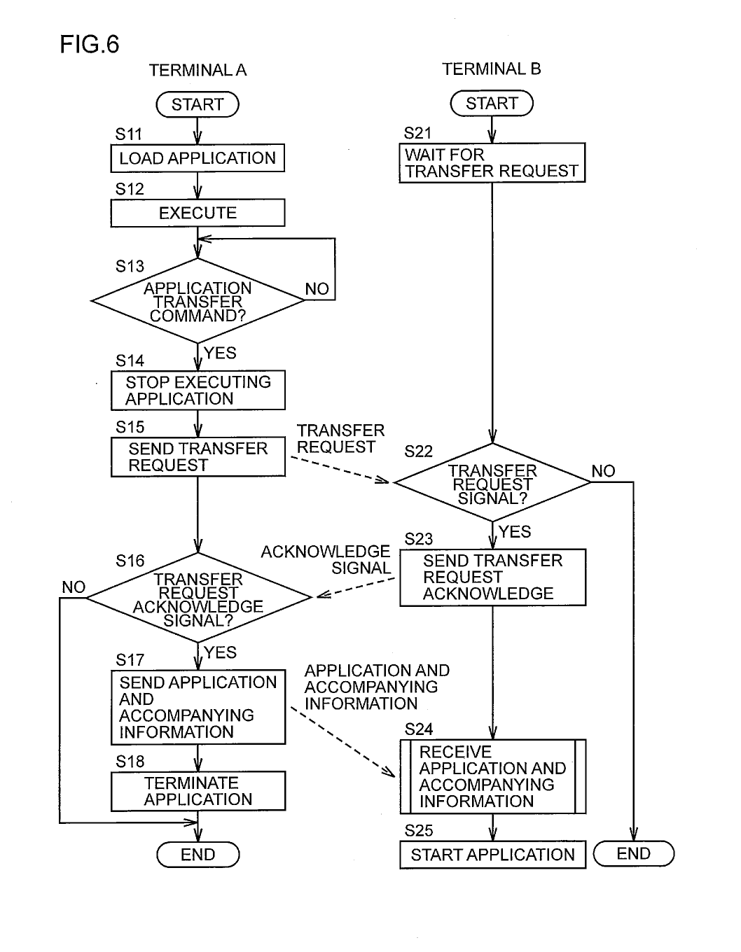

Next, a method for transferring an application from the mobile terminal 10 to the car navigation system 20 will be described. FIG. 6 is a flowchart showing operation of the OSA of the mobile terminal 10 and the OSB of the car navigation system 20 in this case. Hereinafter, the mobile terminal 10 is generally referred to as the “terminal A,” and the car navigation system 20 is generally referred to as the “terminal B.”

Referring to FIG. 6, the terminal A loads an application from an SD card and then executes the application (steps S11, S12). The terminal B is waiting for a transfer request from the user (S21).

If the user decides to transfer the application and inputs this decision via the operation unit 12 of the terminal A shown in FIG. 2, the terminal A stops executing the application (YES in S13, S14). As used herein, the expression “stop executing the application” does not mean terminating the application but means stopping the application while maintaining its operating state. The terminal A then sends a transfer request to the terminal B (S15). That is, the terminal A has a function to stop the application while maintaining its operating state.

In response to the transfer request, the terminal B sends an acknowledge signal to the terminal A to acknowledge the transfer request (YES in S22, S23).

In response to the transfer request acknowledge signal, the terminal A sends the application and its accompanying information to the terminal B and terminates the application (YES in S16, S17, S18). The terminal A sends, wired or wirelessly, the application and the accompanying information directly to the terminal B without using a server on a network etc. The accompanying information includes information on the OS that runs the application.

The routine returns to S15 if the terminal A does not receive the acknowledge signal from the terminal B within a certain period.

In response to the application and the accompanying information, the terminal B performs predetermined processing (S24). The accompanying information will be described later.

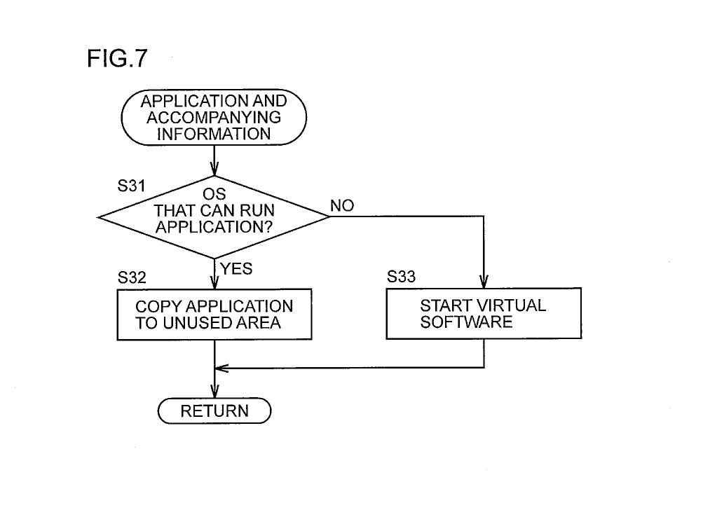

The predetermined processing that is performed by the CPU 21 of the terminal B in S24 will be described below. FIG. 7 is a flowchart showing the details of this predetermined processing. Referring to FIG. 7, in the predetermined processing, the terminal B first refers to the accompanying information to determine if the OS (OSB) of the terminal B is an OS that can run the application (S31). If the OSB is an OS that can run the application (YES in S31), the terminal B copies the application to the unused area of the main memory, and the routine proceeds to S25 in FIG. 6 (S32). Otherwise (NO in S31), the terminal B starts virtual software (S33), and the routine proceeds to S25 in FIG. 6.

What is determined in S31 is not whether the OS of the terminal B is physically the same as the OS that runs the application, but whether the OS of the terminal B can run the application. The CPU 21 operates as determining means and control means.

Specific processing to be performed in the case where the OS (OSB) of the terminal B can run the application (S32 in FIG. 7 and S25 in FIG. 6) will be described below.

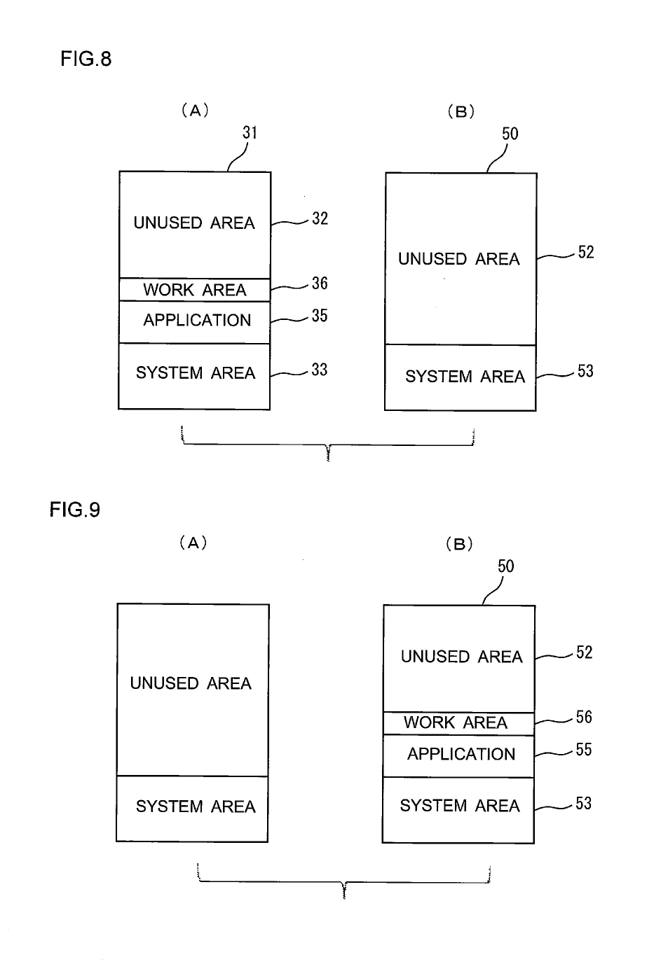

FIGS. 8A, 8B and 9A, 9B are diagrams showing details of the main memories of the terminals A, B in this case. FIGS. 8A and 8B show the state of the terminals A, B before transfer of the application. FIGS. 9A and 9B show the state of the terminals A, B after transfer of the application.

Since the OS of the terminal A is equivalent to that of the terminal B, the system area is the same between the main memories of the terminals A, B. The OS of the terminal A copies, wirelessly or wired, the application 35 and the work area 36 shown in FIG. 8A to the unused area 52 of the main memory 50 of the terminal B shown in FIG. 8B. After copying the areas 35, 36, the OSA of the terminal A terminates the application and erases the data. This state is shown in FIGS. 9A and 9B.

In order for the user to continue the application on the terminal B from the operating state of the application on the terminal A, the terminal A need also transfer the work area as well. Transferring only the application to the terminal B is equivalent to starting the application on the terminal B, and the application is started from its initial state.

That is, transferring both the application and the work area allows the user to continue the application on the terminal B from the operating state of the application on the terminal A.

In other words, transferring both the application and the work area makes the state in the memory which is recognized by the application on the terminal B exactly the same as that in the memory of the terminal A before transfer of the application.

Specific processing to be performed in the case where the OS (OSB) of the terminal B cannot run the application will be described below (S33 in FIG. 7).

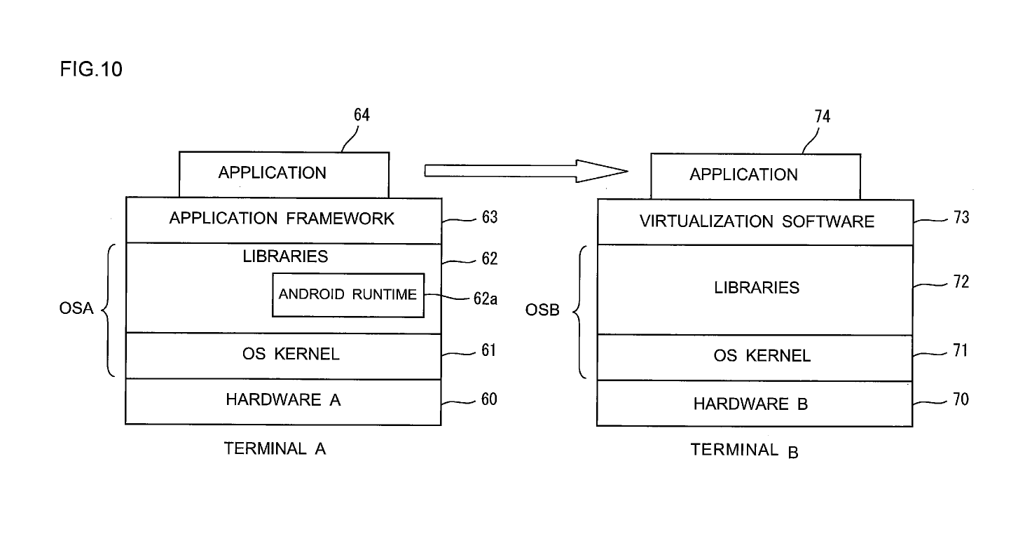

FIG. 10 is a schematic diagram showing the configuration including hardware and software in the terminals A, B in this case. The left side of the figure shows the terminal A, and the right side of the figure shows the terminal B. Referring to FIG. 10, the terminal A includes hardware A, the OSA that can run on the hardware A, an application framework 63 that runs on the OSA, and an application 64 that runs on the application framework. The OSA includes an OS kernel 61 and libraries 62. In the case where the OSA is Android, the libraries 62 include an Android Runtime 62a that will be described later.

Similarly, the terminal B includes hardware B, the OSB that can run on the hardware B, virtualization software 73 that runs on the OSB, and an application 74 that runs on the virtualization software 73. The OSB includes an OS kernel 71 and libraries 72.

The virtualization software 73 installed in the terminal B absorbs the difference between the terminals A, B. In other words, although the application is actually being run on the terminal B, the virtualization software 73 behaves to the application as if the application were being run on the terminal A. In the figure, the terminal B has different hierarchy from the terminal A in the level of the virtualization software 73 and the levels lower than the virtualization software 73 (the libraries 72, the kernel 71, and the hardware 70). However, since the virtualization software 73 performs the same operation as the terminal A, the program can run even on the different hardware.

Examples of the virtualization software include VMware that can execute Linux (registered trademark) applications on Windows (registered trademark) and can execute Windows applications on Linux and that is widely used for the purpose of virtualization of web servers etc., QEMU that can emulate Windows or Linux software and can virtualize hardware together with a part of peripheral hardware, and BlueStacks that can execute Android applications on Windows or Mac.

In the case where a game application is transferred from the terminal A, the virtualization software 73 on the terminal B, instead of the application framework 63, reads the transferred game application 74 onto the memory, not shown, and executes the application 63 from the operating state of the application on the terminal A. Since the work area for storing the progress of the game is transferred simultaneously with the application, the memory is allocated to the application 74 so as to reproduce the state before the transfer.

The above embodiment is described with respect to the case where a game application is transferred. However, the present invention is not limited to this, and map display of a map application may be transferred. In this case, the terminal B reads and executes the map application in a manner similar to that described above. The application requests to obtain a current position via the libraries 72. In fact, it is the virtualization software 73 that receives this request. Since the terminal B operates in exactly the same manner as that of the terminal A and returns the same data as that of the terminal A to the application, the application cannot recognize that it is running on the virtualization software. The terminal B sends the current position to the application via the virtualization software.

The accompanying information will be described below. In the present embodiment, the user can stop executing an application program and can resume the application program on a different terminal. For this purpose, exactly the same state as that at the time execution of the application program is stopped need be reproduced on the terminal to which the application program is transferred, and various accompanying information need be simultaneously transferred in addition to the application program itself and the OS that runs the application program. Such information is herein collectively referred to as the “accompanying information.”

The accompanying information other than the OS includes the following information.

(1) Internal Processing Information of the Application Program

In order to stop a program on one terminal and resume the program on a different terminal after transfer of the program, information on the execution state of the program on the one terminal and information on the state at that time the program is stopped are required. Accordingly, the accompanying information is internal information such as the executed part of the program at the time the program is stopped and the state of the application at that time.

(2) Information on the Size of the Work Area Secured for the Application and the Data in this Work Area

The accompanying information is the data in the memory secured for the application and the size of this memory.

Such information is required to reproduce exactly the same memory data on the virtualization software of the terminal to which the application is transferred.

(3) Data in Video Memory

Data in a video memory is transferred so that the virtualization software of the terminal to which the application is transferred can use the data displayed on the screen of the terminal from which the application is transferred.

(4) Unique User ID for the Application

In specific OSs, a unique user ID is sometimes assigned to each application for security purposes. If application software can access an area allocated to different application software, software such as viruses can be easily created. As measures against this, in the specific OSs, a different user ID is assigned to each application. A memory area allocated to one application cannot basically be accessed by an application with a different user ID, which is advantageous in terms of security.

The user ID can never change during execution of the application. Accordingly, in this application transfer method, the same user ID need be assigned even after transfer of the application to resume the application. The user ID is therefore transferred together with the application.

(5) Data Storage Folder for the Application and Data in the Data Storage Folder

A data storage folder is allocated to each application. The data storage folder is similar to the work area described in (2), but is different from the work area in (2) in that data is temporarily stored in the work area and is erased when the application is terminated, whereas data in the data storage folder is retained even after the power is off. For example, in the case of an email application, since data of an email message is stored in this area, the email massage does not disappear even if the email application is terminated and restarted.

(6) Resources of the Application

The term “resources” refers to image data and data such as music which are used in the application. For example, data such as an icon image representing a specific application, a character or logo that is displayed on a menu screen, and background music and sound effects of games is treated as separate from the application itself, but this data is necessary to execute the application. Accordingly, this data need be transferred simultaneously with the application.

The specific OSs are not described in the present embodiment. However, for example, the terminal A operates as follows if it is Android.

Android OS is made of the following five layers. (a) Linux kernel, (b) standard libraries, (c) Android Runtime (an execution environment for executing an application), (d) application framework, and (e) applications.

The Linux kernel (a) processes the most basic part that is close to hardware and that implements basic functions such as memory and process management. This is substantially the same as common personal computers. The applications do not directly interact with the kernel.

The standard libraries (b) are code for implementing various functions. For example, Surface Manager handles display of graphics, and MediaFrameWork plays back video and audio. FreeType is a library for displaying various character fonts in any size.

Android Runtime (c) is an environment for executing an application and provides a basic application program interface (API). This runtime directly executes the applications.

The application framework (d) performs management such as starting, stopping, termination, etc. of the applications. The application framework (d) also notifies the applications of the state of the terminal. The applications directly access only application framework (d) and the libraries (b) and do not access the kernel (a).

An operation example of a common application on Android will be described below with reference to FIG. 10.

The following example is the case where the game application 64 is started.

When the user sends a command to start the game application 64, the application framework 63 reads this application onto the memory to execute the application via the Android Runtime 62a. The application requires a work area in order to store the progress of the game therein. A virtual machine in the Android Runtime 62a therefore secures the memory as the work area to allocate the memory to the game application. The allocated memory is used during execution of the application and is released when operation of the application is terminated (management of the memory is returned to the Android Runtime 62a).

An operation example of map display by a map application will be described below.

When the map application is started, the application 64 is read and executed in a manner similar to that described above. In order to display a map, the latitude and longitude of a current position need be obtained via GPS. The application therefore requests to obtain the current position via core libraries in the Android Runtime 62a. The current position is read from a GPS chip via the Linux kernel and is sent to the application via the Android Runtime 62a.

The receiving terminal B will be described. The terminal B has the virtualization software 73 as described above, and the virtualization software 73 can similarly perform all the functions of the application framework, the libraries, and the core libraries of Android on the hardware of the terminal B.

The following operation is performed in the case where the game application 64 is transferred.

The virtualization software 73 on the terminal B, instead of the application framework 63, reads the transferred game application 74 onto the memory and executes the application from the operating state of the application on the terminal A. A work area for storing the progress of the game is also transferred simultaneously with the application, and the memory is allocated to the application 74 so as to reproduce the state before the transfer.

The following operation is performed when the map display by the map application is transferred. The map application is read and executed in a manner similar to that in the above example. The application 74 requests to obtain a current position via the core libraries in the Android Runtime 62a. In fact, it is not the Android Runtime 62a but the virtualization software 73 that receives this request. However, since the virtualization software 73 operates in exactly the same manner as that of the Android Runtime 62a and returns the same data as that of the Android Runtime 62a to the application, the application cannot recognize that it is running on the virtualization software 72. The terminal B sends the current position to the application via the virtualization software 73. How the data of the current position is actually implemented depends on the specifications of the terminal B as described above.

The above embodiment is described with respect to the case where only the terminal B has virtualization software. However, the present invention is not limited to this, and both terminals A, B may have virtualization software and functions of the terminal from which an application is transferred. In this configuration, desired transfer can be bidirectionally made between the terminals A, B. Moreover, an application executed on the terminal A can be transferred back to the terminal A after being transferred to and executed on the terminal B and all the operating state can be transferred.

The above embodiment is described with respect to the case where the specific OS is Android. However, the present invention is not limited to this, and similar processing can be carried out on any OS.

The above embodiment is described with respect to the case where an application is transferred between a mobile terminal and a car navigation system and the case where map information is displayed by using GPS. However, the present invention is not limited to this. The present invention is also applicable to the case where the user washing a movie on a mobile terminal transfers the movie to a large screen TV and the case where the user playing a game on a mobile terminal transfers the game to a large screen TV.

Although the embodiment of the present invention is described above with reference to the accompanying drawings, the present invention is not limited to the illustrated embodiment. Various modifications and variations can be made to the illustrated embodiment within a scope that is the same as, or equivalent to, that of the present invention.

### INDUSTRIAL APPLICABILITY

Since the application transfer system can transfer an application between any terminals, the present invention can be advantageously used as an application transfer system.

### REFERENCE SIGNS LIST

10 Mobile Terminal
20 Car Navigation System
11, 21 CPU
12, 22 Operation Unit
13, 23 Storage Device
14, 24 Display Unit
15, 25 Communication Unit
31 Main Memory
32 Unused Area
33 System Area
60, 70 Hardware
61, 71 OS Kernel
62, 72 Libraries
64, 65 Application
63 Application Framework
73 Virtualization Software

1. An application transfer system for transferring an application between first and second terminals each having a predetermined operating system (OS), wherein
said first terminal includes transmitting means for transmitting to said second terminal a request to transfer said application and information specifying said predetermined OS of the first terminal, and
said second terminal includes
virtualization software that virtualizes operation of an OS different from said predetermined OS of said second terminal,
receiving means for receiving said transfer request,
determining means for determining if said predetermined OS for said application received by said receiving means is the same as said predetermined OS of said second terminal, and
control means for performing control to execute said application if said determining means determines that said predetermined OS for said application requested to be transferred is the same as said predetermined OS of said second terminal, and to start said virtualization software to execute said application if said determining means determines that said predetermined OS for said application requested to be transferred is different from said predetermined OS of said second terminal.

2. The application transfer system according to claim 1, wherein
said transmitting means transmits, to said second terminal, accompanying information that defines a state of said application at a time said application is transferred.

3. The application transfer system according to claim 2, wherein
said accompanying information includes information indicating an executed part of a program at a time execution of said program on said first terminal is stopped and a state of said application at the time execution of said program on said first terminal is stopped.

4. The application transfer system according to claim 2, wherein
said accompanying information includes a memory size being used by said application.

5. The application transfer system according to claim 1, wherein
said first terminal has said virtualization software.

6. A method for transferring an application between first and second terminals each having a predetermined operating system (OS) and a memory, the method comprising:
transmitting from said first terminal to said second terminal a request to transfer said application;
receiving by said second terminal said transfer request from said first terminal;
determining by said second terminal if said predetermined OS of said first terminal that runs said application requested to be transferred is the same as said predetermined OS of said second terminal; and
executing said application if it is determined that said predetermined OS that runs said application requested to be transferred is the same as said predetermined OS of said second terminal, and starting virtualization software to execute said application if it is determined that said predetermined OS that runs said application requested to be transferred is different from said predetermined OS of said second terminal.

7. A terminal that receives from an external terminal having a predetermined operating system (OS) an application running on said external terminal, and that can run said application, the terminal comprising:
virtualization software that virtualizes operation of an OS different from an OS of said terminal;
receiving means for receiving from said external terminal a request to transfer said application and information specifying said predetermined OS of said external terminal;
determining means for determining if an OS for said application received by said receiving means is the same as said OS of said terminal; and
control means for controlling an execution of said application said determining means determines that said OS for said application requested to be transferred is the same as said OS of said terminal, and to start said virtualization software to execute said application if said determining means determines that said OS for said application requested to be transferred is different from said OS of said terminal.

8. A storage medium for storing a program that causes a second terminal as a computer to receive an application running on an external first terminal having a predetermined operating system (OS) and to run said application, wherein
said second terminal includes virtualization software that virtualizes operation of an OS different from an OS of said second terminal, and
said program is run as
receiving means for receiving from said first terminal a request to transfer said application and information specifying said predetermined OS of said first terminal,
determining means for determining if an OS for said application received by said receiving means is the same as said OS of said second terminal, and
control means for performing control to execute said application if said determining means determines that said OS for said application requested to be transferred is the same as said OS of said second terminal, and to start said virtualization software to execute said application if said determining means determines that said OS for said application requested to be transferred is different from said OS of said second terminal.

9. The application transfer system according to claim 3, wherein said accompanying information includes a memory size being used by said application.

10. The application transfer system according to claim 2, wherein said first terminal has said virtualization software.

11. The application transfer system according to claim 3, wherein said first terminal has said virtualization software.

12. The application transfer system according to claim 4, wherein said first terminal has said virtualization software.
